(19) United States
(12) Patent Application Publication
(10) Pub. No.: US 2024/0168189 A1
(43) Pub. Date: May 23, 2024

(54) SYSTEMS, DEVICES, AND METHODS FOR GENERATING AVERAGE VELOCITY MAPS OF SUBSURFACE FORMATIONS

(71) Applicant: SAUDI ARABIAN OIL COMPANY, Dhahran (SA)

(72) Inventors: Ahmed SALEM, Dhahran (SA); Tamer IBRAHIM, Dhahran (SA); Mohammad ALJINDAN, Dammam (SA)

(73) Assignee: SAUDI ARABIAN OIL COMPANY, Dhahran (SA)

(21) Appl. No.: 18/055,484

(22) Filed: Nov. 15, 2022

(51) Int. Cl. G01V 1/30; G01V 1/28

(52) U.S. Cl. CPC G01V 1/303; G01V 1/282; G01V 2210/6222; G01V 2210/661; G01V 2210/6652

(57) ABSTRACT

In certain embodiments, a method includes generating a set of average velocity controls based on received seismic data, generating a depth to basement model based on received potential fields data, and generating an average velocity model using an interpolation model to interpolate the set of average velocity controls and the depth to basement model. The method may also include generating a variogram model based on the set of average velocity controls, and generating the average velocity model using the interpolation model to interpolate the average velocity controls, the variogram model, and the depth to basement model. The interpolation model may be Kriging with external drift. The external drift may be based on the depth to basement model. Additionally, the method includes generating a structural map of a subsurface formation using the average velocity model.

### FIELD OF THE DISCLOSURE

The present disclosure relates generally to seismic velocity analysis of subsurface formations using geostatistical approaches to generate an average velocity model used for generating a structural map of a subsurface formation and, more particularly, to a method, a device, and a system for generating the average velocity model using Kriging with external drift (KED) interpolation.

### BACKGROUND OF THE DISCLOSURE

Average velocity models enable visualization of subsurface formations that include one or more different sedimentary layers. In hydrocarbon exploration, average velocity models are used to convert time-domain data to depth-domain data that can be used to generate a structural map of underground features. The structural map may be used to identify impermeable sedimentary layers and faults that may trap hydrocarbons such as oil and gas. The average velocity models rely on seismic data captured at control points. A control point is a location at which seismic data is captured within a region of interest. The control point may be at a wellhead or at a vehicle located within the region of interest, for instance. Due to seismic wave dissipation as the wave travels away from the control point, average velocity models may have increased resolution and accuracy near the control point, but lose resolution and accuracy away from the control point.

### SUMMARY OF THE DISCLOSURE

Various details of the present disclosure are hereinafter summarized to provide a basic understanding. This summary is not an extensive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to an embodiment consistent with the present disclosure, a method may include generating a set of average velocity controls based on received seismic data, generating a depth to basement model based on received potential fields data, and generating an average velocity model using an interpolation model to interpolate the set of average velocity controls and the depth to basement model.

In another embodiment, a non-transitory computer-readable medium may store machine-readable instructions, which, when executed by a processor of an electronic device, may cause the electronic device to generate a set of average velocity controls based on received seismic data, generate a depth to basement model based on received potential fields data, and generate an average velocity model using an interpolation model to interpolate the set of average velocity controls and the depth to basement model.

Any combinations of the various embodiments and implementations described herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 is a block diagram of a system for generating average velocity maps of subsurface formations in accordance with certain embodiments.

FIG. 2 is a view of a region of interest having associated seismic and potential fields data in accordance with certain embodiments.

FIG. 3 is a timing and depth chart mapping a sedimentary-basement interface in accordance with certain embodiments.

FIG. 4 is a flow chart of a method for generating average velocity maps of subsurface formations in accordance with certain embodiments.

FIG. 5 is a graph of average velocity controls for received seismic data in relation to depths to basement in accordance with certain embodiments.

FIG. 6 is a variogram model of the set of average velocity controls in accordance with certain embodiments.

FIGS. 7A and 7B are a depth to basement model and an average velocity map, respectively, in accordance with certain embodiments.

FIG. 8 is a chart of error rates for an average velocity model in accordance with certain embodiments.

FIG. 9 depicts a computing environment that can be used to perform methods in accordance with certain embodiments.

### DETAILED DESCRIPTION

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments described herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

An embodiment in accordance with the present disclosure generally relates to methods for generating average velocity maps of subsurface formations. An example of a method includes generating a set of average velocity controls based on received seismic data, where the received seismic data includes at least one of surface seismic data or control shots data. The method also includes generating a depth to basement model based on received potential fields data. Additionally, the method includes generating a variogram model based on the set of average velocity controls. The method includes generating an average velocity model using an interpolation model to interpolate the set of average velocity controls, the variogram model, and the depth to basement model. In a non-limiting example, the method uses Kriging with external drift for the interpolation model. In another non-limiting example, the external drift is based on the depth to basement model. The method includes generating a map of a subsurface formation using the average velocity model to provide a visualization of the structure of the subsurface formation. In a non-limiting example, the map of the subsurface formation provides a visualization of the sedimentary-basement interface of the subsurface formation.

Using the various embodiments described herein to generate the average velocity model from the set of average velocity controls based on seismic data and from the depth to basement model based on potential fields data improves the resolution and accuracy of mapping of the subsurface formation, regardless of a distance from one or more control points associated with the seismic data. Additionally, using the systems and methods described herein enables mapping of a sedimentary-basement interface of the subsurface formation without performing depth or time interpretation for individual sedimentary layers of the subsurface formation. Using potential fields data to compensate for less accurate seismic data between control points reduces a number of well penetrations, surface seismic locations, or a combination thereof, associated with a surface area of the subsurface formation, thereby reducing exploration costs. Accurately mapping the sediment-basement interface informs decisions regarding drilling, such as where to drill given the depth to the basement, thereby reducing exploration costs.

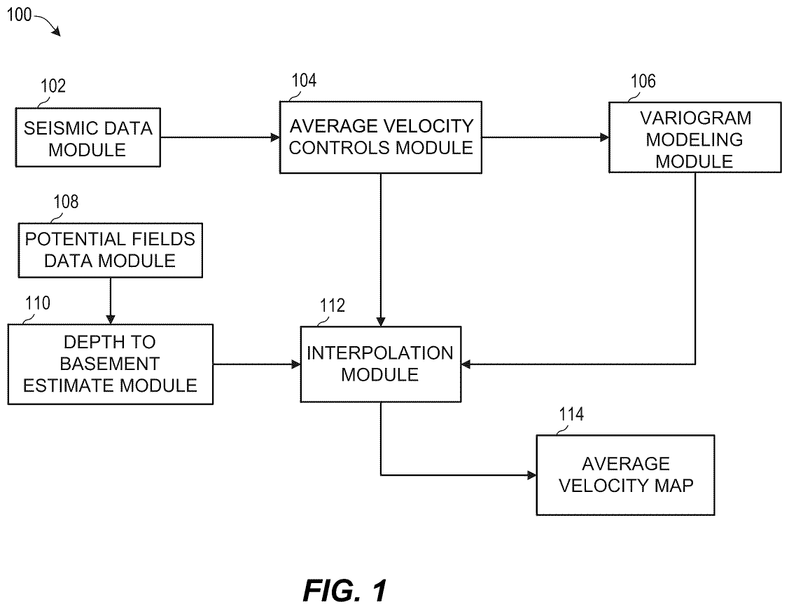

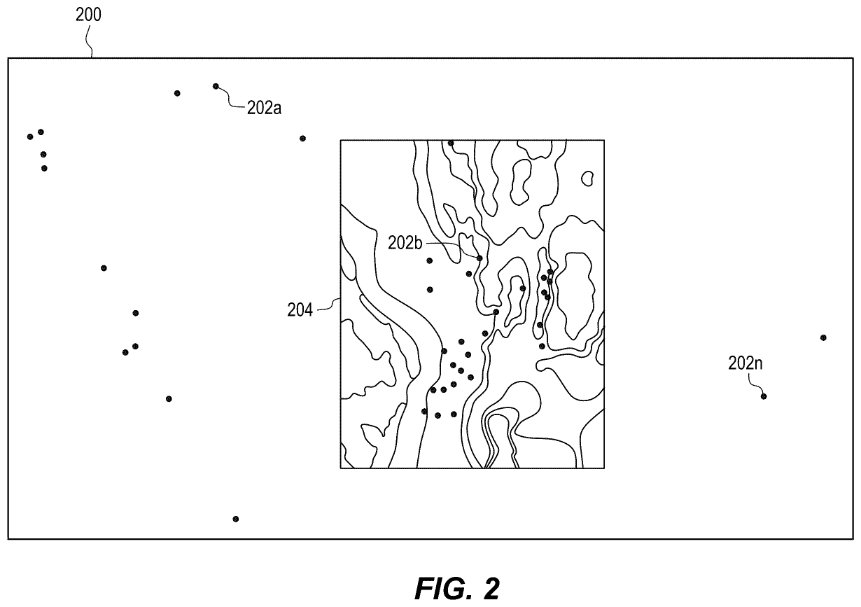

FIG. 1 is a block diagram of a system 100 for generating an average velocity model for mapping subsurface formations in accordance with certain embodiments. A seismic data module 102 receives seismic data associated with a region of interest, and the potential fields data module 108 receives potential fields data associated within the region of interest. FIG. 2 is a non-limiting example of a view of a region of interest 200 having associated seismic and potential fields data in accordance with certain embodiments. The region of interest 200 includes multiple control points that include a control point 202a, a control point 202b, . . . and a control point 202n, and which are herein referred to collectively as control points 202. The control points 202 may be wells, locations of vehicles, or a combination thereof. The region of interest 200 also includes a subregion 204 for which potential fields data is captured, as illustrated by the different regions outlined within the subregion 204.

To capture seismic data, seismic sources (e.g., seismic vibrators, explosions) are activated at different locations within the region of interest 200. A seismic source at a location generates seismic waves that propagate in the subsurface formation. The velocity of a seismic wave depends on properties of the subsurface formation. The properties include density, porosity, and fluid content of the subsurface formation, for example. Different layers of the subsurface formation have different properties, resulting in different seismic velocities. The seismic waves are reflected back toward the surface when a boundary between two layers having different properties, such as a sediment-basement interface, is encountered. The reflected seismic waves are received by one or more sensors (e.g., a geophone-receiver). In some examples, the sensors are disposed within a well associated with one of the control points 202, such as a control point 202a, 202b, 202n, and the received data is referred to as check shot data. In other examples, the sensors are disposed within a vehicle that is mobile within the region of interest 200, and the received data is referred to as surface seismic data. The check shot data and the surface seismic data are herein referred to collectively as seismic data.

Other types of surveys may also be performed within the region of interest 200. The other types of surveys can use a gravimetry method, a magnetometry method, or other similar method that generates potential fields data. In non-limiting examples, the potential fields data is for the subregion 204 of the region of interest 200. In a non-limiting example, the magnetometry survey method is performed by an aerial survey of the subregion 204 to detect magnetic properties of the subsurface formation in the subregion 204. In another non-limiting example, the gravimetry method is performed by a surface survey of the subregion 204 to detect density properties of the subsurface formation of the subregion 204.

Referring again to FIG. 1, in certain embodiments, the seismic data module 102 receives the seismic data associated with the region of interest, and the potential fields data module 108 receives the potential fields data associated with the region of interest. The seismic data module 102 may receive multiple sets of seismic data that includes one or more sets of check shot data associated with the region of interest, one or more sets of surface seismic data associated with the region of interest, or a combination thereof.

The average velocity controls module 104 generates a database of average velocity controls based on the seismic data received by the seismic data module 102. The database of average velocity controls, as used herein, may be referred to as a set of average velocity controls. The variogram modeling module 106 generates a variogram model by applying variogram analysis to the average velocity controls generated by the average velocity controls module 104. The variogram model generated by the variogram modeling module 106 is used to define the covariance Covᵢⱼ between each of the average velocity controls generated by the average velocity controls module 104. In a non-limiting example in which there are three average velocity controls, “between each” indicates that the covariance is determined between a first average velocity control and a second average velocity control, between the first average velocity control and a third average velocity control, and between the second average velocity control and the third average velocity control. The depth to basement estimate module 110 generates a depth to basement model based on the potential fields data received by the potential fields data module 108. An interpolation module 112 generates a linear system of equations to predict an average velocity model based on the set of average velocity controls, the depth to basement model, and the variogram model. The interpolation module 112 generates the average velocity map 114. In a non-limiting example, the interpolation module 112 uses a Kriging with external drift interpolation to predict the average velocity model.

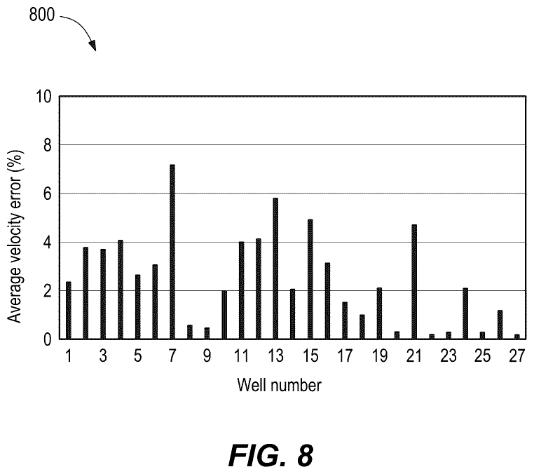

As described below with respect to FIG. 8, one or more of the seismic data module 102, the average velocity controls module 104, the variogram modeling module 106, the potential fields data module 108, the depth to basement estimate module 110, and the interpolation module 112, may be a software module, a hardware module, or a combination thereof, and may include computer-readable media for storage of data, computer-executable instructions, or a combination thereof, as well as other hardware (e.g., a processor, input devices, output devices) for performing operations associated with the corresponding module.

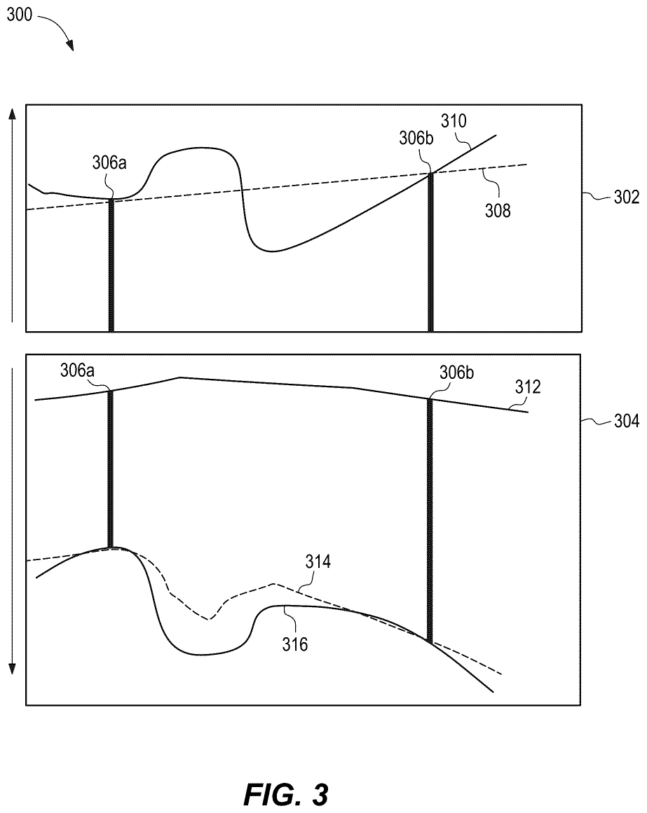

Referring now to FIG. 3, a timing and depth chart 300 mapping a sedimentary-basement interface 316 is shown, in accordance with certain embodiments. The timing and depth chart 300 may be generated using the system described above with respect to FIG. 1 for a two-way seismic section determined by seismic data of a control point 306a and a control point 306b.

In a non-limiting example, a timing chart 302 of the timing and depth chart 300 shows a linear interpolation 308 and a Kriging with external drift model 310 of average velocities at different locations. The linear interpolation 308 shows average velocities at locations between the control points 306a and 306b when average velocity controls are not used, for example. The Kriging with external drift model 310 is generated using the system described above with respect to FIG. 1, for example, and shows average velocities at locations between the control points 306a and 306b when average velocity controls are used.

In non-limiting examples, the Kriging with external drift model 310 interpolates the average velocity control, av, and data of a depth to basement model 314 at a location within the region of interest. The average velocity control at the location is determined using:

av=S+R,
where S is external drift data, and R is a spatially correlated random residual. As a distance between a location and a control point 306a, 306b increases, R approaches zero, as shown by a reference level 312 of a depth chart 304, and the interpolation is controlled by the external drift data. Due to layer compaction, the average velocity within the region of interest is correlated to the depth using:

S=a+bz,
where z is the depth, a is a constant representing a velocity when z=0, and b is a constant. In a non-limiting example, the constant b may be a compaction coefficient. The external drift data of the depth to basement model 314 is assumed to be known within the region of interest defined by seismic data associated with the control points 306a and 306b, so data of the depth to basement model 314 for the location is used as the depth S. Using the average velocity model generated by the Kriging with external drift model 310, a map of the sedimentary-basement interface 316 of the depth chart 304 is generated.

In another non-limiting example, the Kriging with external drift modeling interpolates the average velocity controls between multiple control points and data of the depth to basement model 314 using a linear equation:

$$[ \begin{matrix}[ {Cov}_{ij} ] & {[ {S}_{i} ]}^{T} \\ [ {S}_{j} ] & [ 0 ]\end{matrix} ] \{ \begin{matrix}{λ}_{i} \\ μ\end{matrix} \} = \{ \begin{matrix}{Cov}_{oi} \\ {S}_{o}\end{matrix} \} ,$$

where λᵢ is unknown weight, and Covᵢⱼ is the covariance between the known location of the average velocity control. Covₒᵢ is the covariance between the predicted average velocity and the ith known average velocity control. Sᵢ is the depth to basement trend at the location of the average velocity control. Sₒ is the depth to basement trend at the predicted location o. μ are unknown coefficients of the depth to basement trend. The linear equation may be solved using an algorithm, such as an elimination method or a substitution method. Once the linear equation is solved, the average velocity control at a location o is calculated using:

av(o)=Σᵢ₌₁^{N}λᵢavᵢ.

Kriging with external drift modeling interpolates the covariances, the average velocity controls, and data of the depth to basement model 314 to predict the average velocity model. Using the average velocity model, a map of the sedimentary-basement interface 316 is generated.

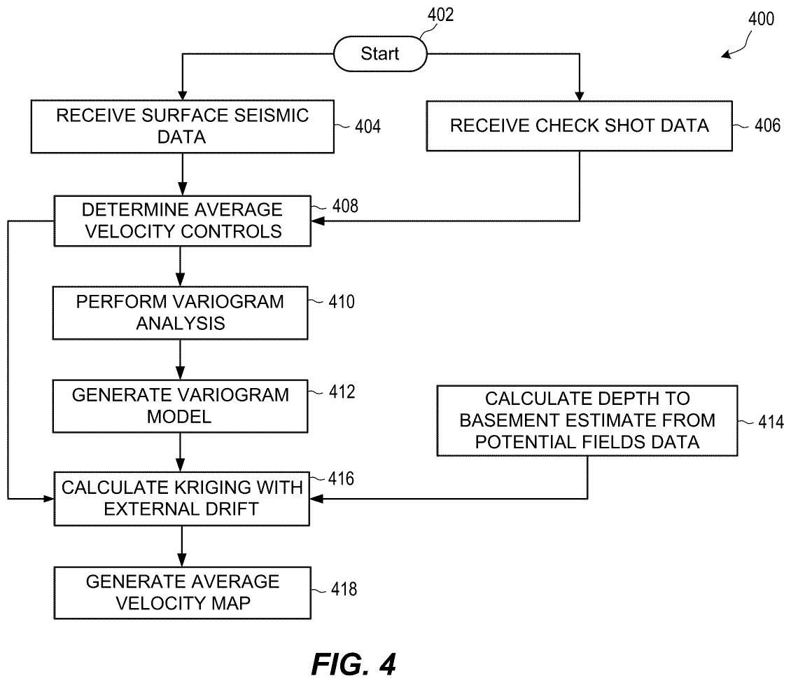

Referring now to FIG. 4, a flow chart of a method 400 for generating average velocity maps of subsurface formations is shown, in accordance with certain embodiments. The method 400 may be performed by a system for generating average velocity maps such as described with respect to FIG. 1 or 3. The method 400 starts at block 402. The method 400 may start in response to receiving an input from a user, a system described herein, or another system communicatively coupled to the system described herein. In a non-limiting example, the method 400 starts at the block 402 in response to an indication that seismic data is available. The method 400 includes receiving surface seismic data at a block 404 and receiving check shot data at a block 406. As described above in accordance with certain embodiments, in a non-limiting example, the method 400 includes receiving at least one of surface seismic data or checks shot data. In another non-limiting example, the method 400 includes receiving one or more sets of surface seismic data or one or more sets of checks shot data. The method 400 also includes determining average velocity controls at a block 408. Additionally, the method 400 includes performing a variogram analysis at a block 410. At a block 412, the method 400 includes generating a variogram model. The method 400 also includes calculating depth to basement estimates from potential fields data at a block 414. At a block 416, the method 400 includes calculating Kriging with external drift. The method 400 includes generating an average velocity map at a block 418.

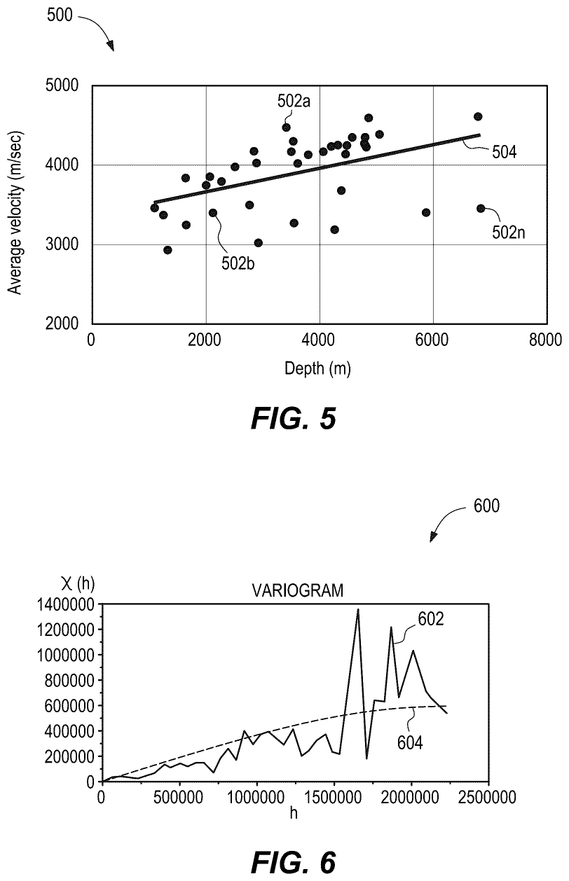

Referring now to FIG. 5, a graph 500 of average velocity controls for received seismic data in relation to depth to basement is shown, in accordance with certain embodiments. The graph 500 includes a control point 502a, a control point 502b, . . . a control point 502n, and an average velocity control indicator 504. The control points 502a, 502b, . . . 502n may be herein referred to collectively as control points 502. In certain embodiments, before applying the Kriging with external drift model, the graph 500 showing the relationship between the average velocity controls and the depth for locations at the control points 502 is generated. The graph 500 may be generated by a seismic data module (e.g., the seismic data module 102) or an average velocity controls module (e.g., the average velocity controls module 104), in a non-limiting example. In various embodiments, the control points are at wellheads associated with wells having known depths, and the seismic data is check shot data. The average velocity control indicator 504 is determined using the equation for determining an average velocity control at a location,

av=S+R,
where

S=a+bz.
R is determined as 3376.6 and b is 0.1491, so the resulting equation for the average velocity control indicator 504 is:

av=0.1491z+3376.6.

The average velocity control indicator 504 illustrates that there is a linear correlation between the average velocity controls and the depth to basement.

FIG. 6 is a graph 600 of a variogram model 604 based on experimental variogram 602 in accordance with certain embodiments. In a non-limiting example, the variogram model 604 is a spherical variogram model based on the experimental variogram 602 using a zero-nugget effect. The variogram model 604 is a variogram model for average velocity controls obtained from the seismic data and used by the Kriging with external drift method. The graph 600 may be generated by a variogram modeling module (e.g., the variogram modeling module 106), in a non-limiting example.

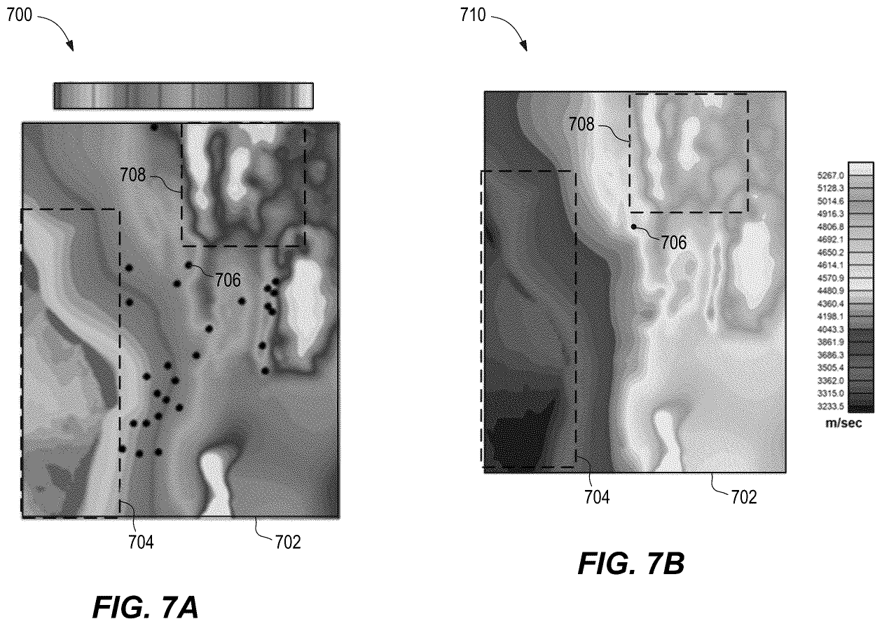

FIGS. 7A and 7B are a depth to basement model 700 and an average velocity map 710, respectively, in accordance with certain embodiments. Referring now to FIG. 7A, the depth to basement model 700 is a depth to basement model based on received potential fields data for the region of interest 702. In a non-limiting example, a potential fields data module (e.g., the potential fields data module 108) receives the potential fields data, and a depth to basement estimate module (e.g., the depth to basement estimate module 110) generates the depth to basement model 700.

Referring now to FIG. 7B, the average velocity map 710 is an average velocity map of the region of interest 702. In a non-limiting example, an interpolation module (e.g., the interpolation module 112) generates the average velocity map 710. In a non-limiting example, the average velocity map 710 is a map of a basement-sedimentary interface of the region of interest 702.

Referring again to FIGS. 7A and 7B, collectively, the regions 704, 708 and the control point 706 illustrate differences between the depths determined using the depth to basement model 700 and the average velocity map 710. The average velocity map 710 indicates that the basement-sedimentary interface at the control point 706 is deeper than the depth to basement model 700 indicates. The average velocity map 710 indicates that the basement-sedimentary interface in the region 704 is deeper in places than the depth to basement model 700 indicates. Additionally, the average velocity map 710 indicates that the basement-sedimentary interface in the region 708 is deeper in places than the depth to basement model 700 indicates and that the depths are more uniformly distributed than the depth to basement model 700 indicates.

Referring now to FIG. 8, a chart of error rates 800 for an average velocity model is shown, in accordance with certain embodiments. To demonstrate the practical utility of using Kriging with external drift interpolation of average velocity controls, covariances, and depth to basement estimates to generate an average velocity model, the method is tested in a region of interest having associated potential fields data, which include 27 control points. The control points are wellheads having check shot data available.

To generate the chart of error rates 800, and by way of example only, the systems described herein use the methods described herein 27 times, excluding one of the 27 check shot data during each iteration. The results are each compared to the average velocity model generated when none of the check shot data is excluded. The chart of error rates 800 shows the percentage errors between each result and the average velocity model. None of the percentage errors exceed 7.2%. Lateral variations in the velocity between the control points may impact the quality of the results. However, average velocity controls computed from surface seismic data can be used as additional constraints to reduce the errors.

Using the Kriging with external drift interpolation described in the embodiments results in the linear transformation between the velocity and depth to basement map. The residual is zero at the location of the average velocity controls because the variogram modeled uses no nugget effect. The average velocity map obtained by using the Kriging with external drift interpolation is equivalent to an average velocity trend that is linearly related to the depth to basement and is controlled by the average velocity controls at the control points.

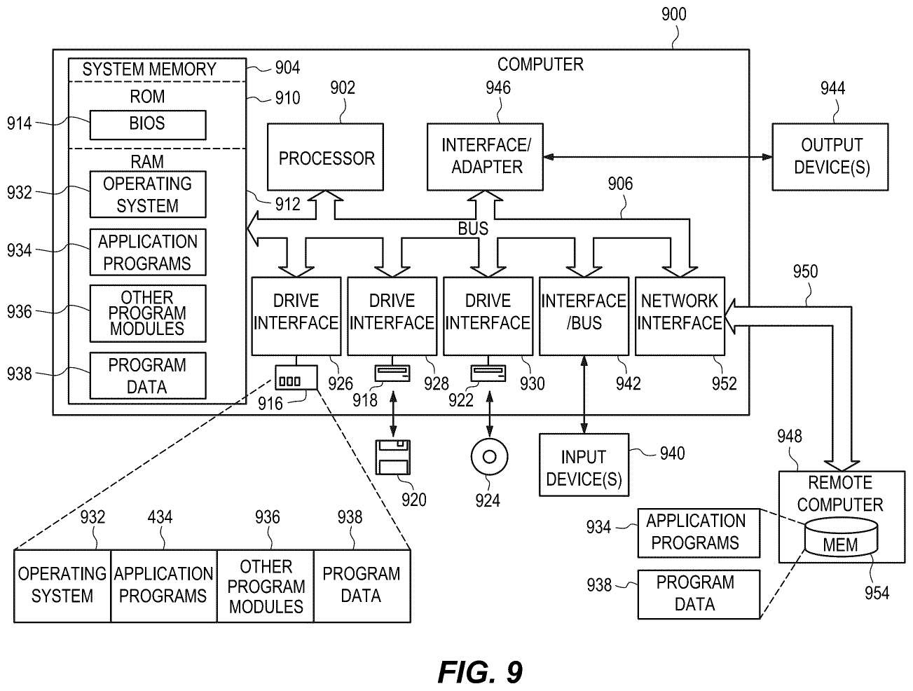

In view of the foregoing structural and functional description, those skilled in the art will appreciate that portions of the embodiments may be embodied as a method, data processing system, or computer program product. Accordingly, these portions of the present embodiments may take the form of an entirely hardware embodiment, an entirely software embodiment, or an embodiment combining software and hardware, such as shown and described with respect to the computer system of FIG. 9. Furthermore, portions of the embodiments may be a computer program product on a computer-usable storage medium having computer readable program code on the medium. Any non-transitory, tangible storage media possessing structure may be utilized including, but not limited to, static and dynamic storage devices, hard disks, optical storage devices, and magnetic storage devices, but excludes any medium that is not eligible for patent protection under 35 U.S.C. § 101 (such as a propagating electrical or electromagnetic signal per se). As an example and not by way of limitation, a computer-readable storage media may include a semiconductor-based circuit or device or other IC (such as, for example, a field-programmable gate array (FPGA) or an ASIC), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. A computer-readable non-transitory storage medium may be volatile, nonvolatile, or a combination of volatile and non-volatile, where appropriate.

The system described herein can include one or more wired and/or wireless networks, including, but not limited to: a cellular network, a wide area network (“WAN”), a local area network (“LAN”), a combination thereof, and/or the like. One or more wireless technologies that can be included within the system described herein can include, but are not limited to: wireless fidelity (“Wi-Fi”), a WiMAX network, a wireless LAN (“WLAN”) network, BLUETOOTH® technology, a combination thereof, and/or the like. For instance, the system described herein can include the Internet and/or the Internet of Things (“IoT”). In various examples, the system described herein can include one or more transmission lines (e.g., copper, optical, or wireless transmission lines), routers, gateway computers, and/or servers, such as described herein. Further, the system and components of the system described herein can include one or more network adapters and/or interfaces (not shown) to facilitate communications with other components of the system.

Certain embodiments have also been described herein with reference to block illustrations of methods, systems, and computer program products. It will be understood that blocks of the illustrations, and combinations of blocks in the illustrations, can be implemented by computer-executable instructions. These computer-executable instructions may be provided to one or more processor of a general purpose computer, special purpose computer, or other programmable data processing apparatus (or a combination of devices and circuits) to produce a machine, such that the instructions, which execute via the processor, implement the functions specified in the block or blocks.

These computer-executable instructions may also be stored in computer-readable memory that can direct a computer or other programmable data processing apparatus to function in a particular manner, such that the instructions stored in the computer-readable memory result in an article of manufacture including instructions which implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks.

In this regard, FIG. 9 illustrates one example of a computer system 900 that can be employed to execute one or more embodiments of the present disclosure. Computer system 900 can be implemented on one or more general purpose networked computer systems, embedded computer systems, routers, switches, server devices, client devices, various intermediate devices/nodes or standalone computer systems. Additionally, computer system 900 can be implemented on various mobile clients such as, for example, a personal digital assistant (PDA), laptop computer, pager, and the like, provided it includes sufficient processing capabilities.

Computer system 900 includes processing unit 902, system memory 904, and system bus 906 that couples various system components, including the system memory 904, to processing unit 902. Dual microprocessors and other multi-processor architectures also can be used as processing unit 902. System bus 906 may be any of several types of bus structure including a memory bus or memory controller, a peripheral bus, and a local bus using any of a variety of bus architectures. System memory 904 includes read only memory (ROM) 910 and random access memory (RAM) 912. A basic input/output system (BIOS) 914 can reside in ROM 910 containing the basic routines that help to transfer information among elements within computer system 900.

Computer system 900 can include a hard disk drive 916, magnetic disk drive 918, e.g., to read from or write to removable disk 920, and an optical disk drive 922, e.g., for reading CD-ROM disk 924 or to read from or write to other optical media. Hard disk drive 916, magnetic disk drive 918, and optical disk drive 922 are connected to system bus 906 by a hard disk drive interface 926, a magnetic disk drive interface 928, and an optical drive interface 930, respectively. The drives and associated computer-readable media provide nonvolatile storage of data, data structures, and computer-executable instructions for computer system 900. Although the description of computer-readable media above refers to a hard disk, a removable magnetic disk and a CD, other types of media that are readable by a computer, such as magnetic cassettes, flash memory cards, digital video disks and the like, in a variety of forms, may also be used in the operating environment; further, any such media may contain computer-executable instructions for implementing one or more parts of embodiments shown and described herein.

A number of program modules may be stored in drives and RAM 912, including operating system 932, one or more application programs 934, other program modules 936, and program data 938. In some examples, the application programs 934 can include seismic data module 102, average velocity controls module 104, variogram modeling module 106, potential fields data module 108, depth to basement estimate module 110, and Kriging with external drift module 112, and the program data 938 can include the timing and depth chart 300, the graph 500, the variogram model 604, the depth to basement model 700, and the average velocity map 114, 710. The application programs 934 and program data 938 can include functions and methods programmed to generate average velocity maps of subsurface formations, such as shown and described herein.

A user may enter commands and information into computer system 900 through one or more input devices 940, such as a pointing device (e.g., a mouse, touch screen), keyboard, microphone, joystick, game pad, scanner, and the like. These and other input devices 940 are often connected to processing unit 902 through a corresponding port interface 942 that is coupled to the system bus, but may be connected by other interfaces, such as a parallel port, serial port, or universal serial bus (USB). One or more output devices 944 (e.g., display, a monitor, printer, projector, or other type of displaying device) is also connected to system bus 906 via interface 946, such as a video adapter.

Computer system 900 may operate in a networked environment using logical connections to one or more remote computers, such as remote computer 948. Remote computer 948 may be a workstation, computer system, router, peer device, or other common network node, and typically includes many or all the elements described relative to computer system 900. The logical connections, schematically indicated at 950, can include a local area network (LAN) and a wide area network (WAN). When used in a LAN networking environment, computer system 900 can be connected to the local network through a network interface or adapter 952. When used in a WAN networking environment, computer system 900 can include a modem, or can be connected to a communications server on the LAN. The modem, which may be internal or external, can be connected to system bus 906 via an appropriate port interface. In a networked environment, application programs 934 or program data 938 depicted relative to computer system 900, or portions thereof, may be stored in a remote memory storage device 954.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation are used herein merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, as used herein, the terms “coupled” or “coupled to” or “connected” or “connected to” or “attached” or “attached to” may indicate establishing either a direct or indirect connection, and is not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments described, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

The invention claimed is:

1. A method, comprising:
generating a set of average velocity controls based on received seismic data;
generating a depth to basement model based on received potential fields data; and
generating an average velocity model using an interpolation model to interpolate the set of average velocity controls and the depth to basement model.

2. The method of claim 1, further comprising:
generating a variogram model based on the set of average velocity controls; and
wherein the interpolation model interpolates the set of average velocity controls, the variogram model, and the depth to basement model.

3. The method of claim 1, wherein the interpolation model is a Kriging with external drift model.

4. The method of claim 3, wherein the external drift is based on the depth to basement model.

5. The method of claim 1, further comprising generating a structural map of a subsurface formation using the average velocity model.

6. The method of claim 5, wherein the subsurface formation includes a sediment-basement interface.

7. The method of claim 1, wherein the received seismic data includes surface seismic data and check shot data.

8. The method of claim 7, wherein generating the set of average velocity controls based on the received seismic data further comprises:
determining average velocity controls for the surface seismic data; and
determining average velocity controls for the check shot data.

9. A non-transitory computer-readable medium storing computer-executable instructions, which, when executed by a processor of an electronic device, cause the electronic device to:
generate a set of average velocity controls based on received seismic data;
generate a depth to basement model based on received potential fields data; and
generate an average velocity model using an interpolation model to interpolate the set of average velocity controls and the depth to basement model.

10. The non-transitory computer-readable medium of claim 9, wherein the processor is further configured to:
generate a variogram model based on the set of average velocity controls, and
wherein the interpolation model interpolates the set of average velocity controls, the variogram model, and the depth to basement model.

11. The non-transitory computer-readable medium of claim 9, wherein the interpolation model is Kriging with external drift.

12. The non-transitory computer-readable medium of claim 11, wherein the external drift is based on the depth to basement model.

13. The non-transitory computer-readable medium of claim 9, wherein the processor is further configured to generate a structural map of a subsurface formation using the average velocity model.

14. The non-transitory computer-readable medium of claim 9, wherein the received seismic data includes surface seismic data and check shot data.

15. The non-transitory computer-readable medium of claim 14, wherein to generate the set of average velocity controls based on the received seismic data, the processor is further configured to:
determine average velocity controls for the surface seismic data; and
determine average velocity controls for the check shot data.
